(19) United States
(12) Patent Application Publication
(10) Pub. No.: US 2021/0082052 A1
(43) Pub. Date: Mar. 18, 2021

(54) MULTIDIMENSIONAL RISK PROFILING FOR IMPROVED QUANTIFICATION AND MODELING OF OPTIMAL ALTERNATIVE SELECTION STRATEGIES

(71) Applicant: Modern Allocator Inc., New York, NY (US)

(72) Inventor: David M. BERNS, New York, NY (US)

(21) Appl. No.: 17/023,268

(22) Filed: Sep. 16, 2020

Related U.S. Application Data
(60) Provisional application No. 62/901,630, filed on Sep. 17, 2019.
(60) Provisional application No. 62/913,653, filed on Oct. 10, 2019.

(51) Int. Cl. G06Q 40/06; G06F 17/18; G06Q 10/06

(52) U.S. Cl. CPC G06Q 40/06; G06Q 10/0635; G06Q 10/0633; G06F 17/18

(57) ABSTRACT

Certain aspects of the present disclosure provide a method of modeling optimal alternative selection strategies based on a multidimensional risk profile, including: presenting, to a user of an application via a graphical user interface, a plurality of question sets, wherein each question set in the plurality of question sets is associated with a different risk dimension; receiving, from the user of the application via the graphical user interface, a plurality of answers associated with the plurality of question sets; determining, based on the received answers, a plurality of risk parameters associated with the user; configuring a utility model based on the plurality of risk parameters; selecting an alternative from a plurality of alternatives that returns a maximum expected value based on the utility model; and displaying, to the user of the application via the graphical user interface, the alternative.

### CROSS-REFERENCE TO RELATED APPLICATIONS

This application claims the benefit of U.S. Provisional Patent Application No. 62/901,630, filed on Sep. 17, 2019, and the benefit of U.S. Provisional Patent Application No. 62/913,653, filed on Oct. 10, 2019, the entire contents of each of which are incorporated herein by reference.

### INTRODUCTION

Aspects of the present disclosure relate to multidimensional risk profiling for improved quantification and modeling of optimal alternative selection strategies.

Models are often used to select between alternatives of any sort. For example, a model may be used to select between different investment strategies.

Conventional models for selecting investment strategies, such as different allocations of investable assets, tend to focus primarily or exclusively on a person's aversion to risk. In such cases, the person may be tested to measure their risk aversion, and a model may select a strategy based on the measured risk aversion.

In some cases, conventional methods of selecting investment strategies may be even less sophisticated, such as relying on basic heuristics or “rules of thumb”, such as a fixed percentage of equities and bonds based on a person's age.

In yet further cases, an investment professional (e.g., an advisor) may simply place a person into one of a few predefined investment strategy “buckets” based on a completely subjective feel of the person's aversion to risk.

All of the aforementioned conventional methods for selecting investment strategies fail to take advantage of advancements in various technical fields, such as behavioral science, neuroeconomics, and others, which have been shown to be directly applicable to the design of optimal alternative selection strategies.

For example, prospect theory showed that a person's aversion to risk—one possible consideration in the design of any investment strategy—is asymmetric and context-specific; i.e., that person will react differently between potential losses and potential gains based on their specific context. Nevertheless, conventional investment strategy selection methods rely on models that assume a completely rational person following a symmetric risk aversion model without regard to context.

And because existing models fail to quantify, for example, additional dimensions of risk associated with a person's preferences, a technical problem exists with respect to how to create a model that properly selects an optimal investment strategy for that person. Consequently, a significant number of people are being directed to allocate their investments in ways that do not match their actual preferences. This disconnect frequently results in sub-optimal investment performance from the perspective of the investor, which may then lead to customer loss for an advisor, investment product provider, or the like.

Accordingly, systems and methods are needed for quantifying and modeling optimal alternative selection strategies based on multidimensional risk profiles.

### BRIEF SUMMARY

Certain embodiments provide a method of modeling optimal alternative selection strategies based on a multidimensional risk profiles, including: presenting, to a user of an application via a graphical user interface, a plurality of question sets, wherein each question set in the plurality of question sets is associated with a different risk dimension; receiving, from the user of the application via the graphical user interface, a plurality of answers associated with the plurality of question sets; determining, based on the received answers, a plurality of risk parameters associated with the user; configuring a utility model based on the plurality of risk parameters; selecting an alternative from a plurality of alternatives that returns a maximum expected value based on the utility model; and displaying, to the user of the application via the graphical user interface, the alternative.

Further embodiments provide non-transitory computer-readable mediums comprising computer-executable instructions that, when executed by a processor of a processing system, cause the processing system to perform the aforementioned methods as well as other methods described herein.

Further embodiments provide a processing system configured to perform the aforementioned methods as well as other methods described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of a method for determining a multidimensional risk profile.

FIG. 2 depicts an example of a user interface screen for presenting questions to a person regarding risk preferences.

FIG. 3A depicts an example user interface screen for inputting balance sheet information and FIG. 3B depicts an example of moderating risk parameters based on standard of living risk.

FIG. 4 depicts an example model output of optimized investment strategies based on multidimensional risk profiling.

FIG. 5 depicts an example of a user interface screen for configuring an investment asset set.

FIG. 6 depicts an example of a user interface screen for configuring capital market assumptions.

FIG. 7 depicts an example of a user interface screen for performing optimization of an investment strategy.

FIG. 8 depicts an example method of modeling optimal alternative selection strategies based on a multidimensional risk profile.

FIG. 9 depicts an example processing system for performing methods of modeling optimal alternative selection strategies based on a multidimensional risk profile.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to multidimensional risk profile-based investment strategy selection methods. Such methods improve on conventional, unidimensional risk profile-based investment strategies, which fail to consider other dimensions of risk that inform a person's actual risk preferences.

The methods described herein provide a tractable technical solution to the technical problem of how to optimize the selection of an investment strategy, such as an allocation of investable assets, from a practically unlimited number of possible strategies based on a modest number of experimentally-derived risk profile parameters. Further, the methods described herein provide an improved interface for self-directed investors as well as investment advisors, which determines a person's multidimensional risk profile and uses it to determine an optimal selection between investment strategy alternatives.

### Multidimensional Risk-Based Utility Models

Generally, a utility model is a quantitative function configured to represent a person's preferences (by way of measured utilities) between a set of alternatives of any sort, such as preferences between alternative investments. Thus, generally, a person's most preferred alternative is the alternative that maximizes their utility model.

Conventional utility models (or functions) used for choosing optimal investment strategies for a person are based on a single dimension of risk. However, because risk is fundamentally multidimensional, such unidimensional risk-based utility models do not accurately reflect a person's actual risk preferences. Consequently, an investment strategy chosen based on a conventional, unidimensional risk utility model may not actually represent the best investment strategy for a given person. Accordingly, methods described herein utilize a multidimensional risk-based utility model, which accounts for more than just a single dimension of risk.

In particular, the multidimensional risk-based utility models described herein include parameterized dimensions for risk aversion, loss aversion, and reflection. Generally speaking, risk aversion measures a person's preferences towards reducing volatility; loss aversion measures a person's preferences towards avoiding loss versus acquiring equivalent gain; and reflection measures a person's different preferences with respect to negative and positive prospects.

For example, in one embodiment, a multidimensional risk-based utility model that accounts for the three aforementioned risk dimensions may be expressed as:

$$U = \{ \begin{matrix}2 - {W}^{( 1 - γ )} for r \geq 0 \\ 2 - λ {W}^{( 1 - γ )} for r < 0 , ϕ = 0 \\ 2 + {λ ( 2 - W )}^{( 1 - γ )} for r < 0 , ϕ = 1\end{matrix} \qquad ( Equation 1 )$$

In the above utility model: U is utility; W is the single period change in wealth 1+r, where r is the single period return; λ is a parameter for loss aversion; γ is a parameter for risk aversion; and φ is a parameter for reflection, which in this embodiment can take on the value of 0 or 1 only.

The above multidimensional risk-based utility model improves upon conventional unidimensional risk-based utility models by capturing complex, real-world preferences with a modest number of risk-related parameters, here: λ, γ, φ. Thus, the above multidimensional risk-based utility model also provides a technical solution to the problem of how to optimize the selection of an investment strategy, such as an allocation of investable assets, from a practically unlimited number of possible strategies based on a modest number of experimentally-derived risk profile parameters.

### Multidimensional Risk Profiling and Utility Model Configuration

Models, such as the utility model discussed above with respect to Equation 1, have parameters. In some embodiments, the parameters may be experimentally derived, such as through testing, and then used as part of a person's profile, such as a risk profile.

Conventional methods of profiling a person for purposes of selecting an investment strategy that maximizes utility for that person have focused solely on determining that person's risk aversion. Such unidimensional risk profiles, however, have been shown to misrepresent a person's actual risk preferences because risk has been shown to be multidimensional.

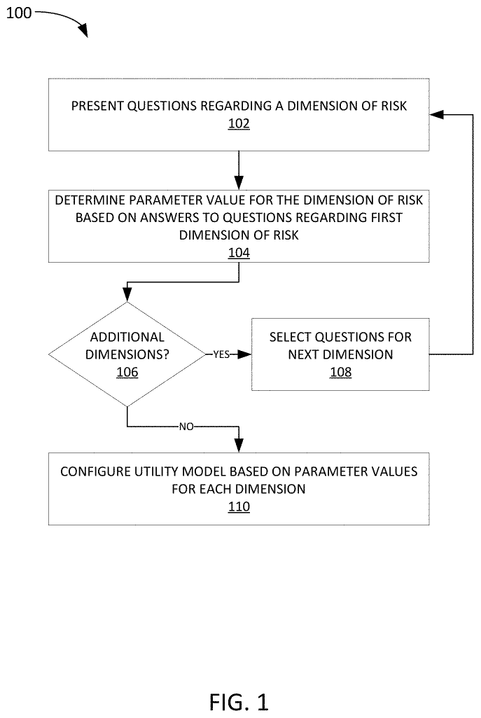

Methods described herein utilize multidimensional risk profile tests in order to derive independent parameters associated with different dimensions of risk, such as loss aversion, risk aversion, and reflection. FIG. 1 depicts an example of a method 100 for determining a multidimensional risk profile.

Method 100 begins at step 102 with presenting questions regarding a dimension of risk to a person. The dimension of risk may be any sort of risk dimension, such as those described above (loss aversion, risk aversion, and reflection). In other embodiments, additional or alternative risk-related parameters may be used.

The questions may be presented, for example, in a user interface of an application, such as a mobile application, desktop application, web-based application, or the like. Or, as another example, the questions may be asked to a person over a phone or in person and the answers recorded by the person asking the questions.

Method 100 then proceeds to step 104 with determining a parameter value for each dimension of risk addressed by the questions, such as λ, γ, φ, based on the answers to the questions presented in step 102.

In some embodiments, the parameter value for each dimension of risk may be based on a number of questions answered one way or another. In some embodiments, each question may have a binary answer (e.g., yes or no/prefer option A or B/etc.), which makes scoring based on answers more straightforward. In some embodiments, some or all of the questions are “lottery-style” questions.

In some embodiments, a parameter value may be determined mathematically based on the content of the question. For example, a set of questions may be arranged such that numerical values in the questions increment in one direction question after question. A person answering the question may then answer the questions in sequence and “tip” over from one answer (e.g., “yes”) to another answer (e.g., “no”) in a binary set of answers. The numerical values at the tip-over point may then be used to calculate the parameter associated with the question set.

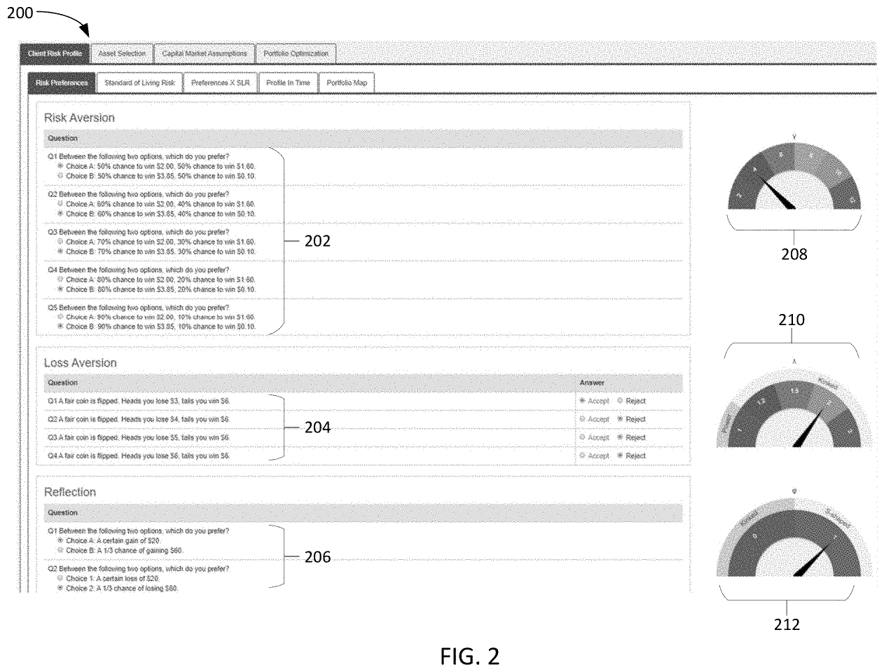

For example, FIG. 2 depicts a question set 204 associated with a loss aversion risk dimension. Notably, the value for winning is the same for all questions: $6. However, the value for losing starts at $3 in the first question (Q1) and increments $1 at a time through the four questions to $6 in the last question (Q4). The tip-over happens at the second question because the answer series changes from “Accept” to “Reject” at Q2. In this particular example, then, the parameter for loss aversion, λ, is given a value of $6/$3=2 (as shown in interface element 210) because the values in Q1 are the last values that the person would accept. If instead, the person answered “Accept” to Q1 and Q2 and “Reject” to Q3 and Q4, then λ=6/4=1.5.

In yet further embodiments, different patterns or combinations of answers may be associated with different parameters without computing the parameter values based on values in the question texts.

Method 100 then proceeds to step 106 with determining whether there are any additional dimensions for testing. For example, a person may have answered questions about loss aversion (one dimension), but not yet about risk aversion, reflection, or some other risk dimension.

If at step 106, there are more dimensions for testing, then questions for a new dimension are selected at step 108 and the process returns to step 102 with presenting the new questions.

If, however, at step 106, there are no more dimensions for testing, then method 100 proceeds to step 110 with configuring a utility model based on the parameter values for each of the tested dimensions.

Note that method 100 is just one example, and others are possible. In some embodiments, a user interface may include questions regarding all dimensions in a single page, screen, or the like, while in other embodiments, the questions may be presented separately (as in method 100) for simplicity, compactness, etc. For example, if presenting questions to a person via a mobile application operating on a mobile device with a relatively smaller screen, the questions may be presented one group/dimension at a time, rather than all at once for convenience.

FIG. 2 depicts an example of a user interface screen 200 for presenting questions to a person regarding risk preferences.

User interface screen 200 may be a part of an application used for performing multidimensional risk profiling and modeling of optimal alternative selection strategies.

As depicted, user interface screen 200 includes a section of question 202 corresponding to a first dimension of risk being tested, which is risk aversion in this example. Similarly, user interface screen 200 includes a second section of questions 204 corresponding to a second dimension of risk being tested, which is loss aversion in this example. Further, user interface screen 200 includes a third section of questions 206 corresponding to a third dimension of risk being tested, which is reflection in this example. In this example, the answers to the questions in each section are binary, i.e., a choice between one of two alternatives, but in other embodiments the answers may take on different forms, such as multiple choices that are not binary, free form answers, or the like.

User interface screen 200 also includes user interface elements 208, 210, and 212, which indicate a parameter value for risk aversion, loss aversion, and reflection respectively, based on the answers to the questions. In some embodiments, these interface elements may be subdued until after all answers to questions for each section are gathered so as not to influence answers.

### Maximizing Expected Utility of an Investment Strategy Based on Multidimensional Risk Profiling

Once a multidimensional risk profile-based utility model is determined and multidimensional risk profiling of a person is complete, as described above, an optimal investment strategy may be determined. In some embodiments, an optimal investment strategy comprises an allocation of investment resources to different types of investable assets, such as in an investment portfolio.

In one embodiment, an investment strategy may be determined by maximizing the expected utility based on the following equation:

E[U^{portfolio}]=Σᵢ₌₁^{S}pᵢΣⱼ₌₁^{N}wⱼU_{i,j}=Σᵢ₌₁^{S}pᵢUᵢ^{portfolio} (Equation 2)

In Equation 2, above, the expected utility (E[U^{portfolio}]) of an investment strategy (e.g., a portfolio in this example) is determined by using the multidimensional risk-based utility model U (Equation 1, above) for each possible asset and scenario and then summing over all N assets and all S scenarios, where the weight of the jth asset in the set of N assets is wⱼ and the probability of the ith scenario is the set of S scenarios is pᵢ.

A scenario is generally one possible joint return outcome for the set of N assets over a selected timeframe. In one example, a scenario could be one possible outcome in a given month, such as equities up 1%, bonds down 2%, etc.

As an example, consider the case of a single asset (N=1) and two scenarios (S=2). If Scenario 1 gives a return of 4% with a 75% probability and Scenario 2 gives a return of 1% with a 25% probability, then the expected utility E[U^{portfolio}] is 0.75*U(r=0.04)+0.25*U(r=0.01). Further, assuming risk parameters of γ=6, λ=1, and φ=0, then U(r=0.04)=1.1781 and U(r=0.01)=1.0485, so the final value for expected utility is then 0.75*1.1781+0.25*1.0485=1.1457. Notably, this is just one simple example with a single asset, but many more assets and scenarios may be considered using expected utility calculations.

In some embodiments, maximizing the expected utility may be performed by an optimization algorithm. Because the utility function is multidimensional (in wⱼ), non-linear (in wⱼ), and constrained such that wⱼ sums to 100%, a constrained nonlinear multivariate optimization method or technique may be used to solve for the wⱼ that maximize utility. For example, an “interior-point” optimization method may be used, such as the primal-dual interior point method for nonlinear optimization. Other optimization methods may be used in other embodiments.

Maximizing expected utility as defined by Equation 2 is a generalized form of optimization that accounts for all moments of the joint return distribution, rather than the conventional practice of optimizing over a small set of lower moments, such as expected return and/or expected volatility. An improvement to conventional practice is optimizing Equation 2 when the multidimensional risk-based utility model of Equation 1 is used.

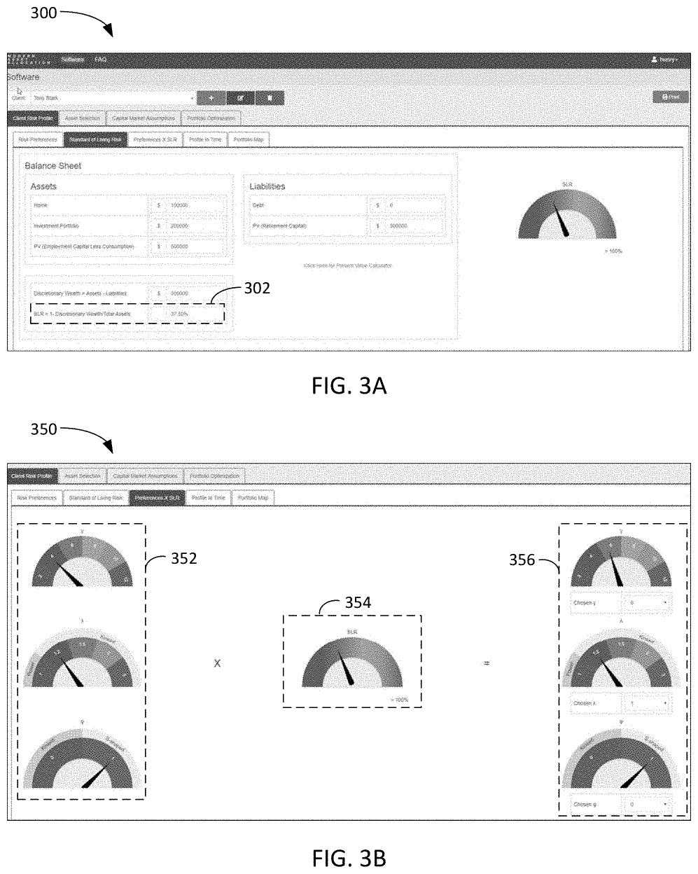

FIG. 3A depicts an example user interface screen 300 for inputting balance sheet information related to a person (e.g., to an investor).

Conventional models for selecting investment strategies do not moderate a risk measure, such as risk aversion, based on any calculated ability of a person to take risk. By contrast, method described herein may determine a measure of a person's ability to take risk in order to moderate the multidimensional risk profile parameters.

In one example, standard of living risk (SLR) is calculated according to a person's ability to take risk with their investment strategy according to:

$$SLR = 1 - \frac{Discretionary Wealth}{Total Assets} \qquad ( Equation 3 )$$

As depicted in FIG. 3A, the balance sheet information regarding assets and liabilities are used to determine a standard of living risk, which is shown in box 302.

An ability to take risk measure, such as SLR, may be used to adjust or “moderate” parameters associated with a person's risk preferences, as shown in FIG. 3B.

In particular, in this example, SLR 354 moderates the calculated loss aversion (λ), risk aversion (γ), and reflection (φ) 352. Parameter moderation may be according to parameter-specific functions. For example, here SLR is applied to these risk dimension parameters based on the following functions:

TABLE 1
Risk Dimension Moderation

| | Measured | Moderated |
|---|---|---|
| Risk Aversion | γ | Max(γ, 2 + 10*SLR) |
| Loss Aversion | λ | Min(λ, , 3 − 2*SLR) |
| Reflection | φ | If SLR ≥ 50% then 0, else φ |

Thus, in this example, the moderating functions moderate the risk parameters γ, λ, and φ if SLR is relatively high, which is based on the concept that a person should not take risk if SLR is high and should likewise not engage in irrational behavioral biases, like loss aversion or reflection. Notably, this is just one example, and other moderating equations can be applied to these and other derived risk parameters.

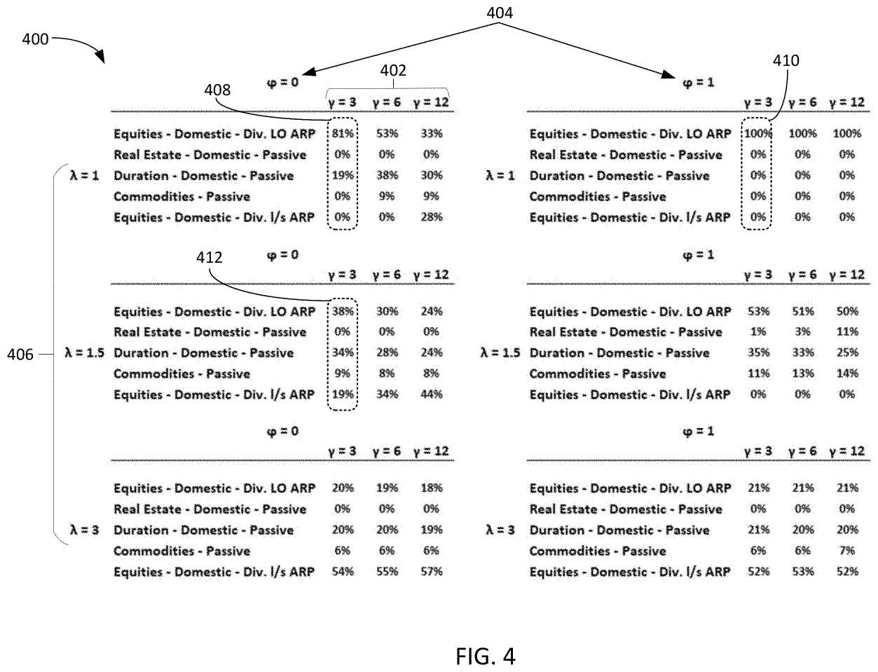

FIG. 4 depicts an example model output 400 of optimized investment strategies based on multidimensional risk profiling.

In this example, the set of assets (Nin Equation 2, above) is limited to the five depicted assets shown in each sub-table for simplicity, however, any number of assets may be considered in other embodiments.

In this example, three dimensions of risk are included, including: loss aversion (λ) along axis 406, risk aversion (γ) along axis 402, and reflection (φ) along axis 404. Critically, the optimal investment strategy is different based on variation along any risk dimension.

For example, for the same risk aversion, γ=3 and reflection φ=0, the optimal investment strategy is different for loss aversion λ=1 (as shown in box 408) and for loss aversion λ=1.5 (as shown in box 412). As another example, for the same risk aversion γ=3 and loss aversion λ=1, the optimal investment strategy is different for reflection φ=0 (as shown in box 408) and for reflection φ=1 (as shown in box 310). Because conventional methods are focused on risk aversion (γ), conventional methods would generally not determine the true optimal investment strategy for a person based on that persons actual, multidimensional risk profile.

### Example User Interfaces

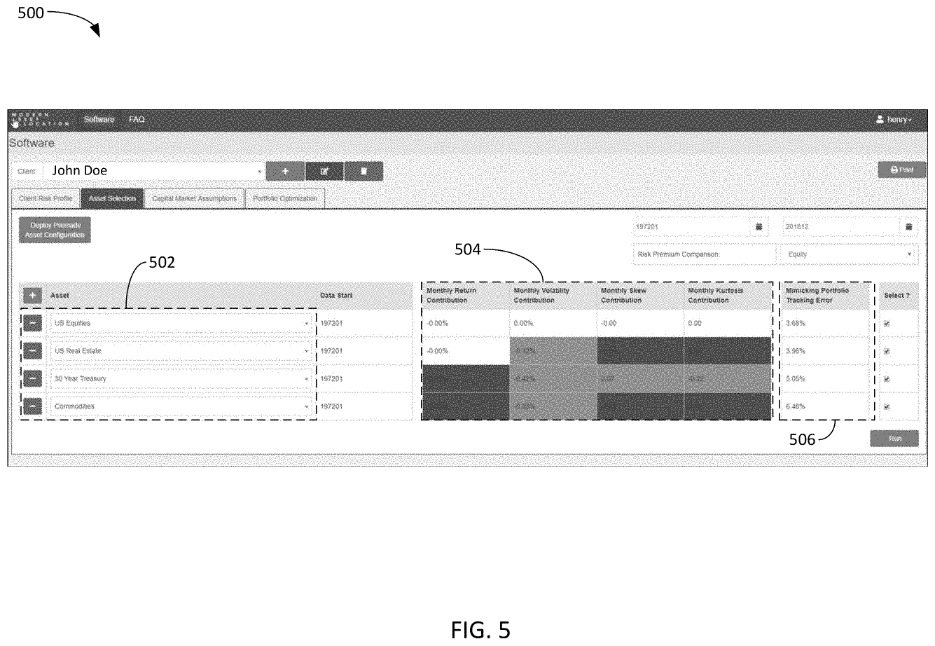

FIG. 5 depicts an example of a user interface screen 500 for configuring an investment asset set.

In the depicted example, the asset set 502 being configured includes four assets: “US Equities”, “US Real Estate”, “30 Year Treasury”, and “Commodities”. Additionally, various characteristics of the selected assets in set 502 are depicted in table 504. These characteristics may be used to design various types of assets sets for which optimal allocations may be determined as above.

Further, table 506 depicts tracking error determinations that indicate whether each asset is redundant to other assets in asset set 502 and thus should be avoided to minimize estimation error.

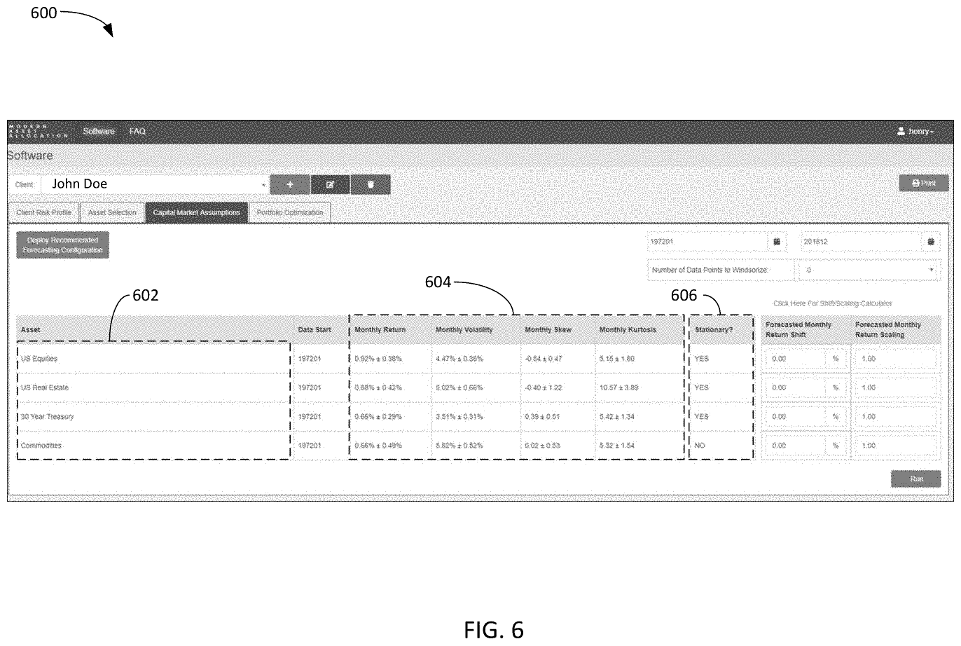

FIG. 6 depicts an example of a user interface screen 600 for configuring capital market assumptions. These capital market assumptions may be configured to help improve the forecast accuracy for investment assets, such as those found in set 602 (and 502 in FIG. 5).

In this example, the asset characteristic table 604 includes monthly return, monthly volatility, monthly skew, and monthly kurtosis, and each of these characteristics includes an error range indication. Further, each of the assets in set 602 includes a “stationary” configuration setting 606, which indicates whether or not past performance is likely to predict future performance.

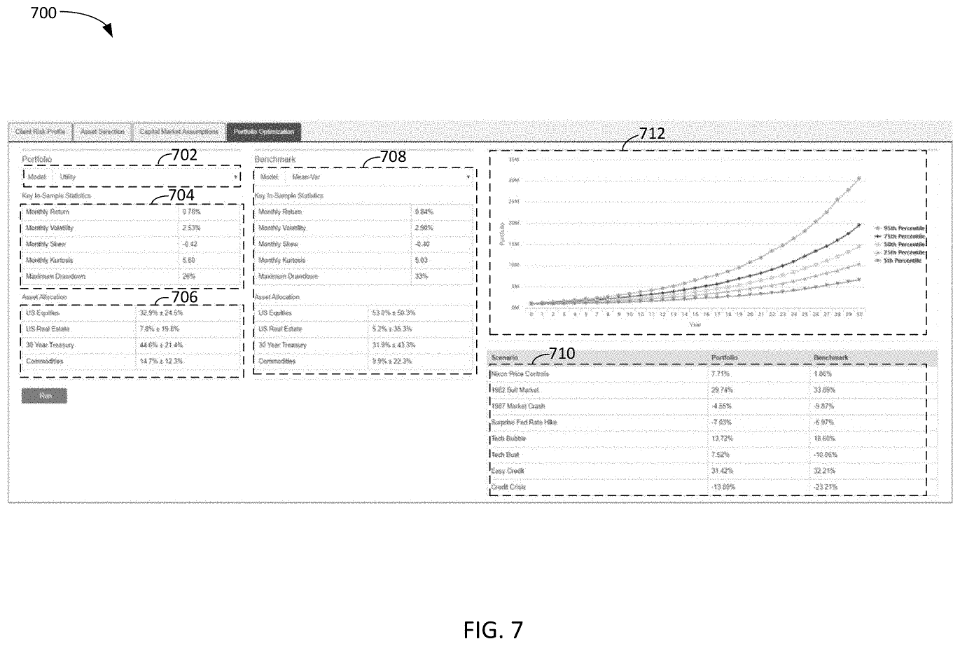

FIG. 7 depicts an example of a user interface screen 700 for performing optimization of an investment strategy.

In this example, the optimization may be run based on the multidimensional risk-based utility model 702 (e.g., Equation 1, above), as described above, to account for a person's multidimensional risk profile.

Here, the optimization based on the multidimensional risk-based utility model outputs an optimal investment strategy (here an asset allocation 706) including confidence intervals as well as a variety of performance metrics 704, which here includes monthly return, monthly volatility, monthly skew, and maximum drawdown. Additionally, a performance graph with multiple series for different confidences is depicted in area 712.

The optimal investment strategy may be compared to one or more selectable benchmarks as shown at 708.

Further in this example, different scenarios 710 are depicted, which show the performance of the optimized investment strategy under different scenarios, which allows for comparing the performance of the optimized investment strategy against those different scenarios.

### Example Method of Modeling Optimal Alternative Selection Strategies Based on a Multidimensional Risk Profiles

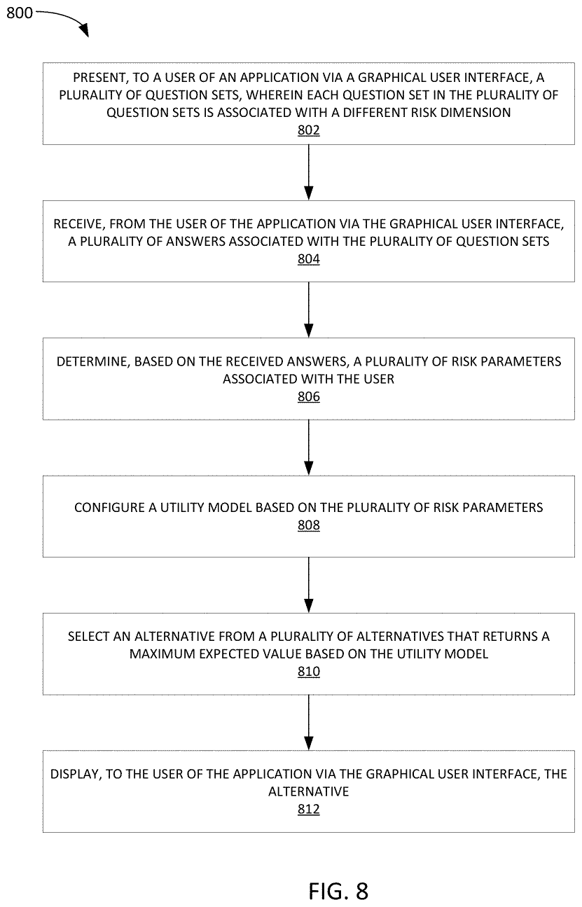

FIG. 8 depicts an example method 800 of modeling optimal alternative selection strategies based on a multidimensional risk profiles.

Method 800 begins at step 802 with presenting, to a user of an application via a graphical user interface, a plurality of question sets. In some embodiments, each question set in the plurality of question sets is associated with a different risk dimension, such as depicted in the example of FIG. 2.

For example, in some embodiments, the plurality of question sets comprises one or more of: a first question set associated with a risk aversion dimension; a second question set associated with a loss aversion dimension; or a third question set associated with a reflection dimension.

Method 800 then proceeds to step 804 with receiving, from the user of the application via the graphical user interface, a plurality of answers associated with the plurality of question sets. For example, FIG. 2 depicts a plurality of answers to the question sets.

Method 800 then proceeds to step 806 with determining, based on the received answers, a plurality of risk parameters associated with the user. For example, as depicted in FIG. 2, a plurality of risk parameters 208, 210, and 212 are determined based on the answer to the question sets.

In one embodiment, the plurality of risk parameters associated with the user comprises one or more of: a risk aversion parameter; a loss aversion parameter; or a reflection parameter.

In some embodiments, determining, based on the received answers, a plurality of risk parameters associated with the user comprises determining at least one risk parameter of the plurality of risk parameters based on numerical values in the question set associated with the at least one risk parameter.

Method 800 then proceeds to step 808 with configuring a utility model based on the plurality of risk parameters. For example, the utility model may be configured with the parameters that are determined in step 806.

In some embodiments, the utility model is Equation 1, as discussed above.

Method 800 then proceeds to step 810 with selecting an alternative from a plurality of alternatives that returns a maximum expected value based on the utility model. For example, FIG. 4 depicts examples of various alternatives based on the determined risk parameters and FIG. 7 depicts an example of a selected alternative. In some embodiments, the alternative comprises one or more investable assets, or a set of investments, such as depicted in FIG. 7.

In some embodiments, the alternative comprises a portfolio of one or more investments, such as stocks, bonds, mutual funds, ETFs, and the like. Notably, these are just some examples of selectable alternatives, and many other are possible.

In some embodiments, selecting an alternative from a plurality of alternatives that returns a maximum expected value for the utility model comprises: performing an optimization technique on an expected value function based on the plurality of alternatives, wherein the optimization technique generates a plurality of values from the expected value function, and each value of the plurality of values is associated with one alternative of the plurality of alternatives; and selecting the alternative with the maximum expected value of the plurality of values. In some embodiments, the expected value function is Equation 2, as described above. Further, in some embodiments, the optimization technique is a constrained nonlinear multivariate optimization technique, such as an interior-point optimization technique.

Method 800 then proceeds to step 812 with displaying, to the user of the application via the graphical user interface, the alternative.

Though not depicted in FIG. 8, some embodiments of method 800 further comprise moderating the plurality of risk parameters based on a measure of the user's ability to take risk. For example, the measure of the user's ability to take risk is a standard of living risk (SLR), such as described above in Equation 3.

### Example Processing System

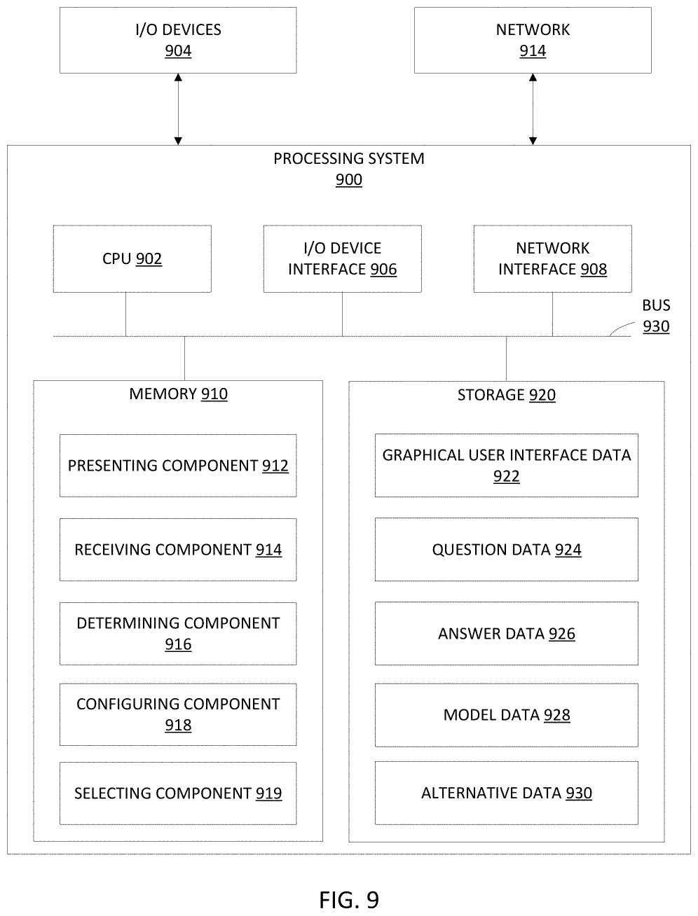

FIG. 9 depicts an example processing system 900 for performing methods of modeling optimal alternative selection strategies based on a multidimensional risk profiles. For example, processing system 900 may be configured to perform one or more aspects of methods 100 and 800, as described above with respect to FIGS. 1 and 8, respectively.

Processing system 900 includes a CPU 902 connected to a data bus 930. CPU 902 is configured to process computer-executable instructions, e.g., stored in memory 910 or storage 920, and to cause processing system 900 to perform methods as described herein, for example with respect to FIGS. 1 and 8. CPU 902 is included to be representative of a single CPU, multiple CPUs, a single CPU having multiple processing cores, and other forms of processing architecture capable of executing computer-executable instructions.

Processing system 900 further includes input/output device(s) 904 and input/output interface(s) 906, which allow processing system 900 to interface with input/output devices, such as, for example, keyboards, displays, mouse devices, pen input, and other devices that allow for interaction with processing system 900. For example, an output device may be used for presenting questions to a user and an input device may be used for receiving answers from the user. In some embodiments, the output and input device may be integrated, such as within a touch-screen display of an electronic device, like a smartphone, tablet computer, portable computer, or the like.

Processing system 900 further includes network interface 908, which provides processing system 900 with access to external networks, such as network 914.

Processing system 900 further includes memory 910, which in this example includes a plurality of components.

For example, memory 910 includes presenting component 912, which is configured to presenting and displaying functions as described above.

Memory 910 further includes receiving component 914, which is configured to receive answers, such as via a graphical user interface of an application, as described above.

Memory 910 further includes determining component 916, which is configured to determine risk parameter as described above.

Memory 910 further includes configuring component 918, which is configured to configure a utility model based on the determined risk parameters, as described above.

Memory 910 further includes selecting component 919, which is configured to select an alternative based on a utility model, such as described above.

Note that while shown as a single memory 910 in FIG. 9 for simplicity, the various aspects stored in memory 910 may be stored in different physical memories, but all accessible CPU 902 via internal data connections, such as bus 930. Further, in some embodiments, various components in memory 910 may be distributed across a distributed computing environment, such as in a cloud-based computing environment.

Processing system 900 further includes storage 920, which in this example includes graphical user interface data 922, question data 924, answer data 926, model data 928, and alternative data 930.

In some embodiments, alternative data 930 may be received from a third-party system, such as a service that reports prices and other aspects of various types of investable assets, like equities, bonds, options, and the like.

While not depicted in FIG. 9, other aspects may be included in storage 920.

As with memory 910, a single storage 920 is depicted in FIG. 9 for simplicity, but the various aspects stored in storage 920 may be stored in different physical storages, but all accessible to CPU 902 via internal data connections, such as bus 930, or external connection, such as network interface 908.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of modeling optimal alternative selection strategies based on a multidimensional risk profiles, comprising:
presenting, to a user of an application via a graphical user interface, a plurality of question sets, wherein each question set in the plurality of question sets is associated with a different risk dimension;
receiving, from the user of the application via the graphical user interface, a plurality of answers associated with the plurality of question sets;
determining, based on the received answers, a plurality of risk parameters associated with the user;
configuring a utility model based on the plurality of risk parameters;
selecting an alternative from a plurality of alternatives that returns a maximum expected value based on the utility model; and
displaying, to the user of the application via the graphical user interface, the alternative.

2. The method of claim 1, wherein the plurality of question sets comprises:
a first question set associated with a risk aversion dimension;
a second question set associated with a loss aversion dimension; and
a third question set associated with a reflection dimension.

3. The method of claim 2, wherein: the plurality of risk parameters associated with the user comprises:
a risk aversion parameter;
a loss aversion parameter; and
a reflection parameter.

4. The method of claim 3, wherein:
the utility model is:
$$U = \{ \begin{matrix}2 - {W}^{( 1 - γ )} for r \geq 0 \\ 2 - λ {W}^{( 1 - γ )} for r < 0 , ϕ = 0 \\ 2 + {λ ( 2 - W )}^{( 1 - γ )} for r < 0 , ϕ = 1\end{matrix} ,$$
U is utility,
W is a single period change in wealth 1+r, where r is a single period return,
λ is the loss aversion parameter,
γ is the risk aversion parameter, and
φ is the reflection parameter.

5. The method of claim 4, wherein selecting an alternative from a plurality of alternatives that returns a maximum expected value for the utility model comprises:
performing an optimization technique on an expected value function based on the plurality of alternatives, wherein the optimization technique generates a plurality of values from the expected value function, and each value of the plurality of values is associated with one alternative of the plurality of alternatives; and
selecting the alternative with the maximum expected value of the plurality of values.

6. The method of claim 5, wherein:
the expected value function E[U^{portfolio}]=Σᵢ₌₁^{S}pᵢΣⱼ₌₁^{N}wⱼU_{i,j}=Σᵢ₌₁^{S}pᵢUᵢ^{portfolio},
N is a set of assets,
S is a set of scenarios,
wⱼ is a weight of the jth asset in the set of assets N, and
pᵢ is a probability of the ith each scenario in the set of scenarios S.

7. The method of claim 6, wherein the optimization technique is a constrained nonlinear multivariate optimization technique.

8. The method of claim 7, wherein the constrained nonlinear multivariate optimization technique is an interior-point optimization technique.

9. The method of claim 1, wherein determining, based on the received answers, a plurality of risk parameters associated with the user comprises determining at least one risk parameter of the plurality of risk parameters based on numerical values in the question set associated with the at least one risk parameter.

10. The method of claim 1, further comprising: moderating the plurality of risk parameters based on a measure of the user's ability to take risk.

11. The method of claim 10, wherein the measure of the user's ability to take risk is a standard of living risk (SLR) according to =
$$1 - \frac{Discretionary Wealth}{Total Assets} .$$

12. The method of claim 1, wherein the alternative comprises a set of investments.

13. A processing system, comprising:
a memory comprising computer-executable instructions;
a processor configured to execute the computer-executable instructions and cause the processing system to perform a method of modeling optimal alternative selection strategies based on a multidimensional risk profiles, the method comprising:
presenting, to a user of an application via a graphical user interface, a plurality of question sets, wherein each question set in the plurality of question sets is associated with a different risk dimension;
receiving, from the user of the application via the graphical user interface, a plurality of answers associated with the plurality of question sets;
determining, based on the received answers, a plurality of risk parameters associated with the user;
configuring a utility model based on the plurality of risk parameters;
selecting an alternative from a plurality of alternatives that returns a maximum expected value based on the utility model; and
displaying, to the user of the application via the graphical user interface, the alternative.

14. The processing system of claim 13, wherein the plurality of question sets comprises:
a first question set associated with a risk aversion dimension;
a second question set associated with a loss aversion dimension; and
a third question set associated with a reflection dimension.

15. The processing system of claim 14, wherein: the plurality of risk parameters associated with the user comprises:
a risk aversion parameter;
a loss aversion parameter; and
a reflection parameter.

16. The processing system of claim 15, wherein:
the utility model is:
$$U = \{ \begin{matrix}2 - {W}^{( 1 - γ )} for r \geq 0 \\ 2 - λ {W}^{( 1 - γ )} for r < 0 , ϕ = 0 \\ 2 + {λ ( 2 - W )}^{( 1 - γ )} for r < 0 , ϕ = 1\end{matrix} ,$$
U is utility,
W is a single period change in wealth 1+r, where r is a single period return,
λ is the loss aversion parameter,
γ is the risk aversion parameter, and
φ is the reflection parameter.

17. The processing system of claim 16, wherein selecting an alternative from a plurality of alternatives that returns a maximum expected value for the utility model comprises:
performing an optimization technique on an expected value function based on the plurality of alternatives, wherein the optimization technique generates a plurality of values from the expected value function, and each value of the plurality of values is associated with one alternative of the plurality of alternatives; and
selecting the alternative with the maximum expected value of the plurality of values.

18. The processing system of claim 17, wherein:
the expected value function is E[U^{portfolio}]=Σᵢ₌₁^{S}pᵢΣⱼ₌₁^{N}wⱼU_{i,j}=Σᵢ₌₁^{S}pᵢUᵢ^{portfolio},
N is a set of assets,
S is a set of scenarios,
wⱼ is a weight of the jth asset in the set of assets N, and
pᵢ is a probability of the ith each scenario in the set of scenarios S.

19. The processing system of claim 18, wherein the optimization technique is a constrained nonlinear multivariate optimization technique.

20. The processing system of claim 19, wherein the constrained nonlinear multivariate optimization technique is an interior-point optimization technique.
